(19) United States
(12) Patent Application Publication
(10) Pub. No.: US 2026/0102945 A1
(43) Pub. Date: Apr. 16, 2026

(54) SCREW EXTRUDER

(71) Applicant: KABUSHIKI KAISHA KOBE SEIKO SHO (KOBE STEEL, LTD.), Hyogo (JP)

(72) Inventors: Kento UEMURA, Takasago-shi (JP); Hiroomi KATANO, Takasago-shi (JP); Martin C. GREEN, Billerica, MA (US); Quentin HARTLEY, Hudson, OH (US)

(73) Assignee: KABUSHIKI KAISHA KOBE SEIKO SHO (KOBE STEEL, LTD.), Hyogo (JP)

(21) Appl. No.: 19/350,641

(22) Filed: Oct. 6, 2025

Related U.S. Application Data
(60) Provisional application No. 63/707,480, filed on Oct. 15, 2024.

(51) Int. Cl. B29B 7/48; B29B 7/58; B29B 7/82; B29K 21/00

(52) U.S. Cl. CPC B29B 7/488; B29B 7/484; B29B 7/582; B29B 7/826; B29K 2021/00

(57) ABSTRACT

A screw extruder includes a tapered screw having a shaft portion and a wing portion, a driving device that rotates the tapered screw, a casing having a passage port through which a material passes, and a die plate attached to the casing so as to close the passage port. The die plate has a first discharge perforation arranged at a position corresponding to the tapered screw. During rotation of the tapered screw, size of an overlapping region between a top surface of the wing portion of the tapered screw and the first discharge perforation when viewed in a material extrusion direction changes periodically. A material extruded by the tapered screw is cut by increase in the overlapping region between the first discharge perforation and the top surface of the wing portion.

### FIELD OF INVENTION

The present invention relates to a screw extruder including a pair of tapered screws.

### BACKGROUND ART

Conventionally, as disclosed in JP 2018-122478 A, JP 2011-73428 A, JP Hei 6-155547 A, JP Sho 57-76832 U, and JP Sho 58-36425 A, screw extruders including a pair of tapered screws are known. Each of a pair of the tapered screws has a shaft portion and a spiral wing portion. A pair of the shaft portions is inclined such that the shaft portions approach each other toward a tip and the tip faces downward. For this reason, when a material is sent toward a tip by the wing portion, the material is gradually pressurized and also flows toward the tip by its own weight. Therefore, retention of the material can be suppressed, and the material can be efficiently extruded.

In the screw extruder disclosed in JP 2018-122478 A and JP 2011-73428 A, a pair of rolls is provided at an extrusion port of a material, and a material is formed into a sheet shape by a pair of the rolls. By this, handling properties including weight control of a material in a post-process are improved. However, in recent years, demand for low fuel consumption tires has increased, and silica is often blended at a high ratio in rubber which is a raw material of the low fuel consumption tires. For this reason, it is difficult to mold a material into a sheet shape in a screw extruder, and there causes a problem in handling properties including weight control of a material in a post-process.

### SUMMARY OF THE INVENTION

An object of the present invention is to provide a screw extruder capable of coping with a material that is difficult to be molded into a sheet shape.

A screw extruder according to an aspect of the present invention includes a pair of tapered screws arranged so as to approach each other toward a tip, each of the pair of tapered screws having a shaft portion and a wing portion spirally provided on an outer peripheral surface of the shaft portion and including a flat top surface, a driving device that generates driving force for rotating the pair of tapered screws, a casing that accommodates the pair of tapered screws and has an inlet for receiving a material and a passage port for allowing a material to pass through, and a die plate attached to the casing so as to close the passage port. The die plate includes a plurality of discharge perforations arranged at positions corresponding to the pair of tapered screws, and positions and shapes of a plurality of the discharge perforations are set such that size of an overlapping region of the top surface of the wing portion of each of the pair of tapered screws and a corresponding discharge perforation when viewed in a material extrusion direction periodically changes when the pair of tapered screws is rotated by the driving device. A material extruded by the pair of tapered screws is cut by increase in the size of the overlapping region between the corresponding discharge perforation and the top surface of the wing portion.

### BRIEF DESCRIPTION OF THE DRAWINGS

FIG. 1 is a cross-sectional view of a screw extruder according to an embodiment as viewed from above.

FIG. 2 is a cross-sectional view of the screw extruder as viewed from the side.

FIG. 3 is an enlarged view of a part of the screw extruder illustrated in FIG. 2.

FIG. 4 is a diagram illustrating a die plate provided in the screw extruder.

FIG. 5 is a diagram illustrating a variation of the die plate.

FIG. 6 is a diagram illustrating a variation of the die plate.

FIG. 7 is a diagram illustrating a variation of the die plate.

### DETAILED DESCRIPTION

Hereinafter, an embodiment of the present invention will be described in detail with reference to the drawings.

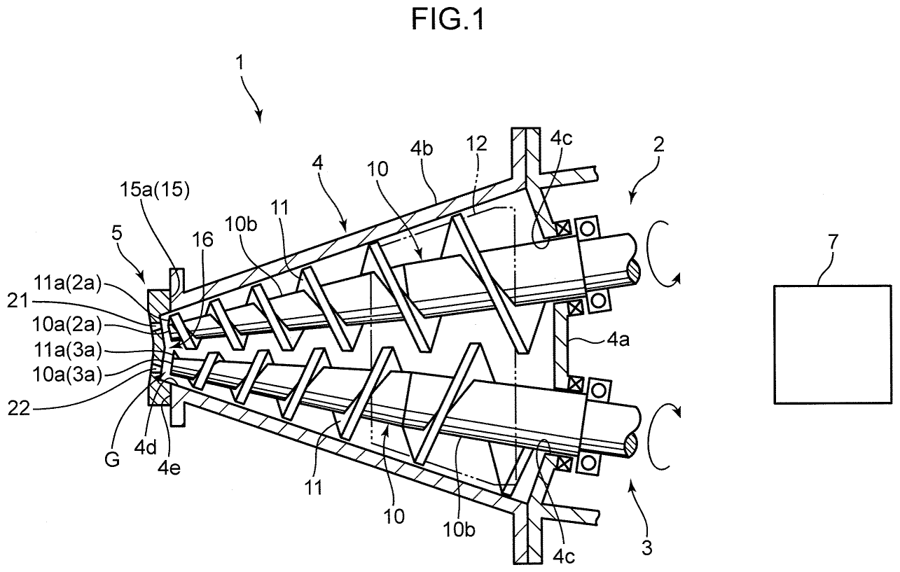

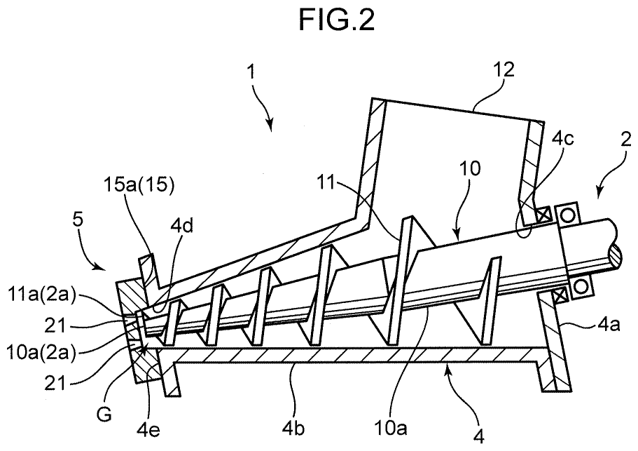

A screw extruder 1 according to the present embodiment is an extruder for pelletizing and extruding a material such as rubber. The extruder 1 includes a pair of left and right tapered screws 2 and 3, a casing 4 accommodating the tapered screws 2 and 3, and a die plate 5 attached to the casing 4. FIG. 1 illustrates the screw extruder 1 in a state where the tapered screws 2 and 3 are viewed from above, and FIG. 2 illustrates the tapered screws 2 and 3 viewed from the side.

Each of the first tapered screw 2 and the second tapered screw 3 has a shaft portion 10 and a wing portion 11 spirally provided on an outer peripheral surface 10b of the shaft portion 10. The first tapered screw 2 and the second tapered screw 3 have a similar structure except that twisting directions of the wing portions 11 are opposite to each other. The first tapered screw 2 and the second tapered screw 3 are driven by a driving device 7 to rotate in opposite directions at the same rotation speed.

The first tapered screw 2 and the second tapered screw 3 are arranged so as to be closer to each other toward a tip. Each of the shaft portions 10 has a shape whose outer diameter gradually decreases toward a tip. Therefore, a distance between the tips of the shaft portions 10 and 10 is shorter than a distance between base ends of the shaft portions 10 and 10. For this reason, as a material is extruded toward a tip, the material is progressively pressurized. For this reason, the material is easily caught by the wing portions 11 and 11, and it is possible to prevent the material from staying in the casing 4. Note that the shaft portion 10 may include a portion having a constant outer diameter in an axial direction at a site on the base end side of the shaft portion 10.

Further, the shaft portions 10 and 10 are arranged in an inclined manner so as to be located lower in the direction of gravity toward the tip. For this reason, when a material is extruded toward the tip, the material is sent also by its own weight, so that the material is easily caught by the wing portions 11 and 11.

The wing portion 11 is provided from the base end to the tip of the shaft portion 10. A top surface 10a of the shaft portion 10 is flat, and a top surface 11a of the wing portion 11 is formed as a flat surface on the same plane as the top surface 10a of the shaft portion 10. Note that, hereinafter, a top surface combining the top surface 11a of the wing portion 11 and the top surface 10a of the shaft portion 10 may be referred to as top surfaces 2a and 3a of the tapered screws 2 and 3.

A protrusion height of the wing portion 11, that is, a height from an outer peripheral surface 10b of the shaft portion 10 to an outer end 11b of the wing portion 11 decreases toward a tip portion of the shaft portion 10.

The casing 4 includes a base end portion 4a and an enclosure portion 4b, the base end portion 4a being configured to support a base end of both the shaft portions 10 and 10, and the enclosure portion 4b being connected to the base end portion 4a and covering a periphery of a pair of the tapered screws 2 and 3. A shaft hole 4c through which the shaft portion 10 passes is formed in the base end portion 4a. In the shaft portion 10, a portion protruding from the shaft hole 4c to the outside of the casing 4 is connected to the driving device 7. The driving device 7 generates driving force for rotating the first tapered screw 2 and the second tapered screw 3 in directions opposite to each other.

The enclosure portion 4b is arranged around a pair of the tapered screws 2 and 3 so as to cover the upper side, both the left and right sides, and the lower side of a pair of the tapered screws 2 and 3. An inlet 12 for receiving a material into the casing 4 is formed in a portion located above the pair of tapered screws 2 and 3 of the enclosure portion 4b. That is, the casing 4 has the inlet 12 for receiving a material. The inlet 12 is located on the upper side in the vicinity of the base end of a pair of the tapered screws 2 and 3.

In the enclosure portion 4b, an end portion on the side opposite to the base portion 4a is opened. This opening is a passage port 4d through which a material extruded by a pair of the tapered screws 2 and 3 passes. That is, the casing 4 has the passage port 4d.

A tip of the first tapered screw 2 and a tip of the second tapered screw 3 enter the passage port 4d. That is, a tip of the shaft portion 10 and a tip of the wing portion 11 are arranged in the passage port 4d so that the top surface 10a of the shaft portion 10 and the top surface 11a of the wing portion 11 approach an inner side surface of the die plate 5 as much as possible. Note that, depending on a shape of the die plate 5, the tip of the shaft portion 10 and the tip of the wing portion 11 do not need to enter the passage port 4d.

The die plate 5 is attached to the casing 4 so as to close the passage port 4d of the casing 4. The die plate 5 includes a connection portion 15 connected to the casing 4 outside the passage port 4d, and a facing portion 16 that is a portion facing the passage port 4d.

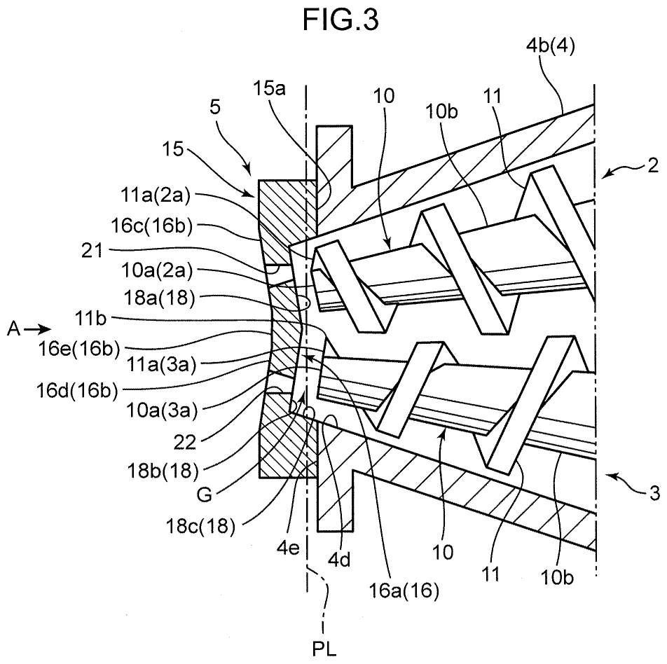

As also illustrated in FIG. 3, an inner side surface 15a of the connection portion 15, that is, the surface 15a facing the casing 4 at the connection portion 15 is fastened to a tip surface 4e of the enclosure portion 4b of the casing 4. An inner side surface 16a of the facing portion 16, that is, the surface 16a on the casing 4 side of the facing portion 16 faces the passage port 4d. An outer peripheral edge of the inner side surface 16a of the facing portion 16 is along an inner peripheral edge of the passage port 4d.

The inner side surface of the die plate 5 has a recessed portion 18 recessed from the inner side surface 15a of the connection portion 15. The recessed portion 18 includes a first bottom surface portion 18a facing the top surface 2a of the first tapered screw 2, a second bottom surface portion 18b facing the top surface 3a of the second tapered screw 3, and a side surface portion 18c along an outer periphery of the first bottom surface portion 18a and the second bottom surface portion 18b. The first bottom surface portion 18a is parallel or substantially parallel to the top surface 2a of the first tapered screw 2. The second bottom surface portion 18b is parallel or substantially parallel to the top surface 3a of the second tapered screw 3.

Both the shaft portions 10 and 10 of a pair of the tapered screws 2 and 3 extend in directions approaching each other toward a tip, and the top surfaces 2a and 3a of the tapered screws 2 and 3 are flat surfaces perpendicular to the extending directions of the corresponding shaft portions 10. For this reason, the top surfaces 2a and 3a of the tapered screws 2 and 3 are not arranged on the same plane, but are slightly inclined with respect to a plane PL perpendicular to an imaginary straight line extending in a longitudinal direction (left-right direction in FIG. 1) of the casing 4. For this reason, the first bottom surface portion 18a is inclined in a first direction with respect to the plane PL (see FIG. 2) in a state of being viewed from above. Further, the second bottom surface portion 18b is inclined in a second direction opposite to the first direction with respect to the plane PL in a state of being viewed from above. Note that the plane PL is also a direction along the passage port 4d.

A gap G between the first bottom surface portion 18a and the top surface 2a of the first tapered screw 2 is preferably 10 mm or less, and more preferably 5 mm or less. Further, the gap G between the second bottom surface portion 18b and the top surface 3a of the second tapered screw 3 is also preferably 10 mm or less, and more preferably 5 mm or less. That is, a material extruded by a pair of the tapered screws 2 and 3 temporarily enters the gap G between the die plate 5 and the top surfaces 2a and 3a of a pair of the tapered screws 2 and 3. As will be described later, this material is cut by the wing portion 11 when flowing into discharge perforations 21 and 22 described later. For this reason, in order to enhance material cutting performance, the gap G between the die plate 5 and the top surfaces 2a and 3a of a pair of the tapered screws 2 and 3 is preferably as narrow as possible. Therefore, the gap G between the top surfaces 2a and 3a of a pair of the tapered screws 2 and 3 and the die plate 5 is preferably set to 10 mm or less or 5 mm or less. Further, the top surfaces 2a and 3a of a pair of the tapered screws 2 and 3 and the die plate 5 are preferably not in contact with each other. Note that, in a case where the top surface 11a of the wing portion 11 and the top surface 10a of the shaft portion 10 are not formed on the same plane, a gap between the top surface 11a of the wing portion 11 and the die plate 5 (or the first bottom surface portion 18a or the second bottom surface portion 18b) may be set to 10 mm or less or 5 mm or less.

An outer side surface 16b in the facing portion 16, that is, the surface 16b facing the side opposite to the casing 4 in the facing portion 16 has a first inclined surface 16c parallel to the first bottom surface portion 18a, a second inclined surface 16d parallel to the second bottom surface portion 18b, and a connection surface 16e located between the first inclined surface 16c and the second inclined surface 16d. Therefore, an outer side surface of the die plate 5 also has a shape recessed from an outer side surface of the connection portion 15. Note that the outer side surface of the die plate 5 is not limited to this shape, and may be formed as a flat surface over the connection portion 15 and the facing portion 16.

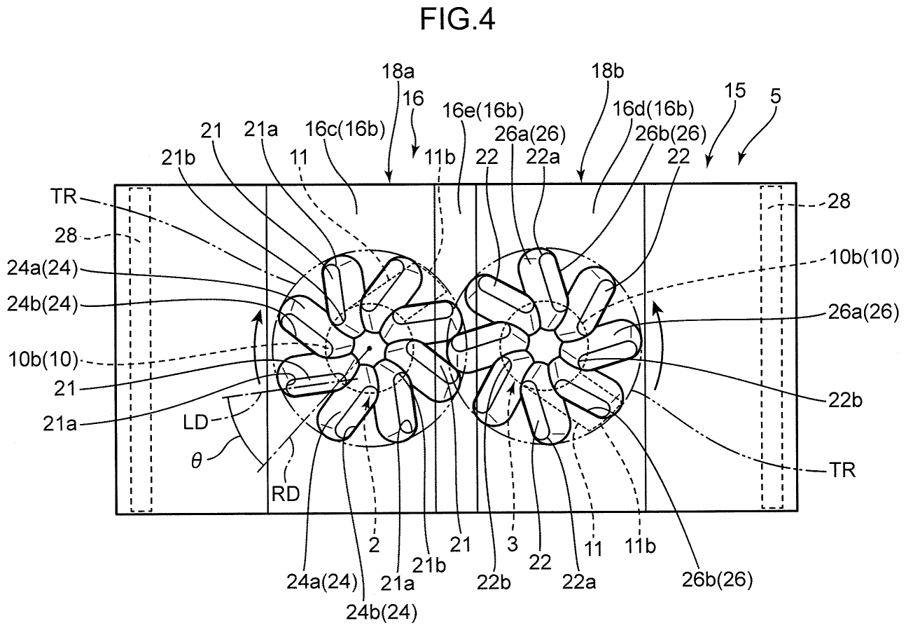

The die plate 5 is provided with a plurality of the discharge perforations 21 and 22. As illustrated in FIG. 4, some of a plurality of the discharge perforations 21 and 22 are arranged at a position corresponding to the top surface 2a of the first tapered screw 2. These discharge perforations are referred to as a plurality of the first discharge perforations 21. The remaining discharge perforations are arranged at a position corresponding to the top surface 3a of the second tapered screw 3. These discharge perforations are referred to as a plurality of the second discharge perforations 22. Note that FIG. 4 illustrates an outer side surface of the die plate 5. The outer side surface of the die plate 5 is a surface of the die plate 5 facing the side opposite to the casing 4, in other words, a surface viewed from a direction of an arrow A in FIG. 3.

A plurality of the first discharge perforations 21 are provided so as to penetrate the facing portion 16 from the first bottom surface portion 18a of the inner side surface 16a to the first inclined surface 16c of the outer side surface 16b. On the other hand, a plurality of the second discharge perforations 22 are provided so as to penetrate the facing portion 16 from the second bottom surface portion 18b of the inner side surface 16a to the second inclined surface 16d of the outer side surface 16b. However, some of the first discharge perforations 21 may extend into the second bottom surface portion 18b. Further, some of the second discharge perforations 22 may extend into the first bottom surface portion 18a.

A plurality of the first discharge perforations 21 are arranged at intervals in a rotation direction of the first tapered screw 2. Each of the first discharge perforations 21 has an elongated shape in a direction inclined with respect to a radial direction RD of the shaft portion 10. That is, since the wing portion 11 protrudes from the outer peripheral surface 10b of the shaft portion 10 in a direction inclined with respect to the radial direction RD of the shaft portion 10, the first discharge perforation 21 is also inclined in the same direction as the inclination direction of the wing portion 11. Note that a direction in which the wing portion 11 protrudes from the outer peripheral surface 10b of the shaft portion 10 and a longitudinal direction LD of the first discharge perforation 21 may be parallel or may not be parallel. In the example illustrated in FIG. 4, the longitudinal direction LD of the first discharge perforation 21 is inclined with respect to the radial direction RD of the shaft portion 10. For example, an angle θ formed by the longitudinal direction LD and the radial direction RD may be 30 degrees to 50 degrees. In a case where the angle θ is such an inclination angle, the first discharge perforation 21 long in the longitudinal direction LD can be provided, which is effective for the screw extruder 1 that discharges a larger pellet. Further, the longitudinal direction LD of the first discharge perforation 21 can be set to a desired angle with respect to the wing portion 11. Note that the longitudinal direction LD is a direction passing through an intersection between the outer peripheral surface 10b of the shaft portion 10 and the radial direction RD and extending along the longitudinal direction LD of the first discharge perforation 21.

In FIG. 4, the first tapered screw 2 on the left side rotates clockwise, and the second tapered screw 3 on the right side rotates counterclockwise.

In the die plate 5, at least a front side surface 24a of an inner peripheral surface 24 defining each of the first discharge perforations 21 is inclined with respect to the first bottom surface portion 18a (or the inner side surface 16a) such that an opening area increases in a material discharge direction. The front side surface 24a referred to here is a side surface on the side toward which the wing portion 11 is directed during rotation of the tapered screw 2. That is, when viewed in a direction in which the shaft portion 10 extends, the wing portion 11 moves from a rear side surface 24b toward the front side surface 24a of the first discharge perforation 21 during rotation of the tapered screw 2.

An inclination angle of the front side surface 24a with respect to the first bottom surface portion 18a (or the inner side surface 16a) is preferably 40 degrees to 60 degrees. In the example illustrated in FIG. 4, the front side surface 24a is inclined with respect to the first bottom surface portion 18a, whereas the rear side surface 24b is orthogonal to the first bottom surface portion 18a (or the inner side surface 16a). However, the inner peripheral surface 24 of the first discharge perforation 21 is not limited to this configuration.

Each of the first discharge perforations 21 is located on the inner side, in a radial direction, of a track TR of the outer end 11b of the wing portion 11 during rotation. That is, an edge portion (also referred to as an outer edge portion 21a) of the first discharge perforation 21 located on the outermost side in the radial direction RD of the shaft portion 10 is also located on the inner side, in the radial direction, of the track TR of the outer end 11b of the wing portion 11. Note that the outer edge portion 21a of the first discharge perforation 21 here means the outer edge portion 21a at the inner side surface 16a of the facing portion 16.

An edge portion (also referred to as an inner edge portion 21b) of the first discharge perforation 21 located on the innermost side in the radial direction RD of the shaft portion 10 is located on the inner side in the radial direction than a track of an inner end of the wing portion 11 (or the outer peripheral surface 10b of the shaft portion 10). Here, the inner edge portion 21b of the first discharge perforation 21 means the inner edge portion 21b at the inner side surface 16a of the facing portion 16.

The inner edge portion 21b may be formed at a position coinciding with a track of an inner end of the wing portion 11 (or the outer peripheral surface 10b of the shaft portion 10), or may be located on the outside, in the radial direction, of a track of an inner end of the wing portion 11 (or the outer peripheral surface 10b of the shaft portion 10). In a case where the inner edge portion 21b is located on the outside, in the radial direction, of a track of an inner end of the wing portion 11 (or the outer peripheral surface 10b of the shaft portion 10), when the wing portion 11 is not located at a position facing to the first discharge perforation 21, the first discharge perforation 21 is entirely opened.

As described above, the outer edge portion 21a of the first discharge perforation 21 is located on the inside, in the radial direction, of the track TR of the outer end 11b of the wing portion 11 during rotation. For this reason, when the first tapered screw 2 rotates, a period in which the top surface 11a of the wing portion 11 overlaps the first discharge perforation 21 occurs over the entire region in the longitudinal direction LD of the first discharge perforation 21. Note that the state in which the top surface 11a of the wing portion 11 overlaps the first discharge perforation 21 means a state in which the top surface 11a of the wing portion 11 appears to overlap at least a part of the first discharge perforation 21 when viewed in a direction in which the shaft portion 10 extends (or a direction perpendicular to the first inclined surface 16c or a direction perpendicular to the first bottom surface portion 18a).

The wing portion 11 sequentially overlaps each of the first discharge perforations 21 when the first tapered screw 2 rotates. For this reason, in each of the first discharge perforations 21, a period in which the top surface 11a of the wing portion 11 overlaps and a period in which the top surface 11a of the wing portion 11 does not overlap are periodically repeated. In other words, a position and a shape of the first discharge perforation 21 are set such that size of an overlapping region between the top surface 11a of the wing portion 11 and the first discharge perforation 21 periodically changes.

In a rotation direction of the shaft portion 10, a width of the first discharge perforation 21 is smaller than a width of the top surface 11a of the wing portion 11. For this reason, when the first tapered screw 2 rotates, there is a period in which the top surface 11a of the wing portion 11 overlaps the first discharge perforation 21 over the entire width in a rotation direction of the shaft portion 10. Further, as described above, the outer edge portion 21a of the first discharge perforation 21 is located on the inside, in the radial direction RD, of the track TR of the outer end 11b of the wing portion 11 during rotation. For this reason, when viewed in a material extrusion direction, the entire one of the first discharge perforations 21 is temporarily closed by the top surface 11a of the wing portion 11 and the top surface 10a of the shaft portion 10. In other words, the top surface 11a of the wing portion 11 has a shape having a period of closing the entire first discharge perforation 21 in cooperation with the top surface 10a of the shaft portion 10 when the tapered screw 2 rotates as viewed in the material extrusion direction. Note that, when viewed in the material extrusion direction, the top surface 10a itself of the shaft portion 10 may have a shape having a period of closing the entire first discharge perforation 21 when the tapered screw 2 rotates.

When the top surface 11a of the wing portion 11 is at a position not overlapping one of the first discharge perforations 21, a material existing around the shaft portion 10 is extruded to the one of the first discharge perforations 21 by the wing portion 11 without being divided. On the other hand, when the top surface 11a of the wing portion 11 passes through a position overlapping the one of the first discharge perforations 21, a material existing around the shaft portion 10 is divided by the wing portion 11 in the gap G between the top surface 11a of the wing portion 11 and the inner side surface 16a in the facing portion 16 of the die plate 5. That is, as an overlapping region between the first discharge perforation 21 and the top surface 11a of the wing portion 11 becomes larger, the material is divided. At this time, since the top surface 11a of the wing portion 11 overlaps the first discharge perforation 21 sequentially from the inner side to the outer side in the radial direction, the material is divided sequentially from the inner side in the radial direction.

When the material is divided, the material becomes a pellet and is discharged through the first discharge perforation 21. At this time, since the front side surface 24a of the first discharge perforation 21 is inclined with respect to the first bottom surface portion 18a, it is possible to suppress the divided material to adhere to the front side surface 24a.

The second discharge perforation 22 is formed in the same manner as the first discharge perforation 21 except that the second discharge perforation 22 is formed in a direction opposite to that of the first discharge perforation 21 in a left-right orientation. That is, a plurality of the second discharge perforations 22 are arranged at intervals in a rotation direction of the second tapered screw 3, and each of the second discharge perforations 22 has an elongated shape in a direction inclined with respect to a radial direction of the shaft portion 10. Further, at least a front side surface 26a of the inner peripheral surface 26 defining the second discharge perforation 22 in the die plate 5 is inclined such that an opening area increases in a material discharge direction. Note that a rear side surface 26b may be inclined or may not be inclined.

Further, each of the second discharge perforations 22 is located on the inner side, in the radial direction, of the track TR of the outer end 11b of the wing portion 11 during rotation. For this reason, an outer edge portion 22a of the second discharge perforation 22 is located on the inside, in the radial direction, of the track TR of the outer end 11b of the wing portion 11. Further, an inner edge portion 22b of the second discharge perforation 22 is located on the inside, in the radial direction, of a track of an inner end of the wing portion 11 (or the outer peripheral surface 10b of the shaft portion 10). However, the inner edge portion 22b may be formed at a position coinciding with a track of an inner end of the wing portion 11 (or the outer peripheral surface 10b of the shaft portion 10), or may be located on the outside, in the radial direction, of a track of an inner end of the wing portion 11 (or the outer peripheral surface 10b of the shaft portion 10).

The wing portion 11 of the second tapered screw 3 sequentially overlaps each of the second discharge perforations 22 when the second tapered screw 3 rotates. For this reason, in each of the second discharge perforations 22, a period in which the top surface 11a of the wing portion 11 overlaps and a period in which the top surface 11a of the wing portion 11 does not overlap are periodically repeated. Further, in a rotation direction of the shaft portion 10, a width of the second discharge perforation 22 is smaller than a width of the top surface 11a of the wing portion 11.

When the top surface 11a of the wing portion 11 is at a position not overlapping one of the second discharge perforations 22, a material existing around the shaft portion 10 is extruded to the one of the second discharge perforations 22 by the wing portion 11 without being divided. On the other hand, when the top surface 11a of the wing portion 11 passes through a position overlapping the one of the second discharge perforations 22, a material existing around the shaft portion 10 is divided by the wing portion 11 in the gap G between the top surface 11a of the wing portion 11 and the inner side surface 16a in the facing portion 16 of the die plate 5.

The die plate 5 is provided with a heater 28 for raising the temperature of the die plate 5. Since the temperature of the die plate 5 is raised by the heater 28, releasability from the die plate 5 of a material after cutting is improved. The heaters 28 are arranged at both ends in a longitudinal direction of the die plate 5. However, the heater 28 is not limited to this position.

As described above, in the present embodiment, a material is gradually pressurized when a pair of the tapered screws 2 and 3 rotates and the material is sent toward the tip by the wing portion 11. In this state, the material flows into a plurality of the discharge perforations 21 and 22 of the die plate 5. When a pair of the tapered screws 2 and 3 rotates, size of an overlapping region changes periodically, the overlapping region being a region between the flat top surface 11a of the wing portion 11 of each of a pair of the tapered screws 2 and 3 and the corresponding discharge perforations 21 or 22 when viewed in the material extrusion direction. Then, when the overlapping region between the discharge perforations 21 and 22 and the top surface 11a of the wing portion 11 becomes large, a material is cut. At this time, since the size of the overlapping region periodically changes, a material continuously flowing into the discharge perforations 21 and 22 is cut every predetermined time interval. For this reason, since there is little variation in size of cutting of a material, it is possible to obtain an extruded material having a predetermined weight without molding of a material into a sheet shape. Therefore, the screw extruder 1 that supports a material that is difficult to be molded into a sheet shape is obtained.

Further, in the present embodiment, the outer edge portions 21a and 22a of the discharge perforations 21 and 22 located on the outermost side in the radial direction RD of the shaft portion 10 are located on the inside, in the radial direction, of the track TR of the top surface 11a of the wing portion 11. For this reason, when viewed in the material extrusion direction, the top surface 11a of the wing portion 11 passes through the entire region of the discharge perforations 21 and 22 except a portion facing the shaft portion 10. For this reason, it is possible to prevent a material from being left uncut in the entire region of the discharge perforations 21 and 22 in the radial direction RD of the shaft portion 10.

Further, in the present embodiment, since the temperature of the die plate 5 can be raised by the heater 28, it is possible to suppress to adhere a material after cutting to the die plate 5.

Further, in the present embodiment, at least the front side surfaces 24a of the discharge perforations 21 and 22 are inclined such that an opening area increases in the material discharge direction. For this reason, it is possible to suppress a material after cutting to adhere to and staying on the front side surfaces 24a of the discharge perforations 21 and 22. That is, if a material is cut and adheres to the inner peripheral surfaces 24 of the discharge perforations 21 and 22, the material may stay in the discharge perforations 21 and 22. In that case, the material may be connected to a material that is extruded next. For this reason, since at least the front side surfaces 24a of the discharge perforations 21 and 22 are inclined, adhesion of a cut material to the front side surfaces 24a of the discharge perforations 21 and 22 is suppressed. For this reason, adhesion between the cut materials can be suppressed.

Note that a width of the first discharge perforation 21 in a rotation direction of the shaft portion 10 may be the same as or larger than a width of the top surface 11a of the wing portion 11. Even in a case where a width of the first discharge perforation 21 is larger than a width of the top surface 11a of the wing portion 11, there is a period in which the wing portion 11 overlaps the first discharge perforation 21. During this period, the first discharge perforation 21 is not entirely closed, but only a part of the first discharge perforation 21 is closed. However, since the outer end 11b of the wing portion 11 is located outside the outer edge portion 21a of the first discharge perforation 21 in the radial direction RD of the shaft portion 10, the wing portion 11 passes through the entire first discharge perforation 21 in the radial direction RD of the shaft portion 10. Thus, a material may be separated by the wing portion 11.

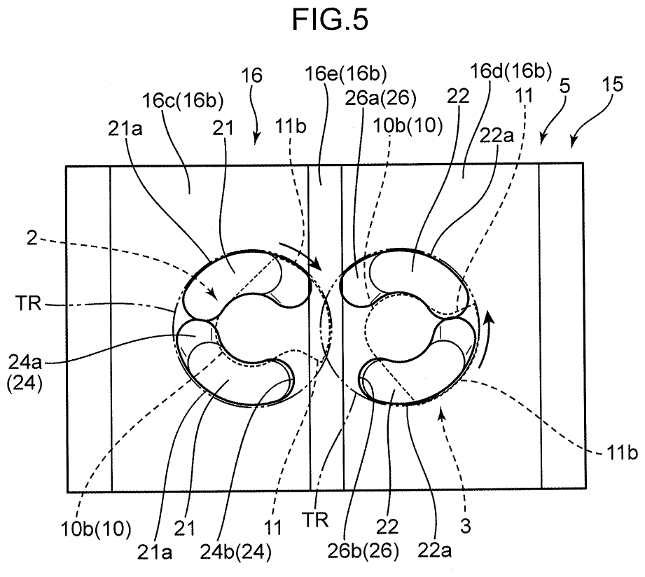

For example, in the die plate 5 illustrated in FIG. 5, a width of the first discharge perforation 21 is larger than a width of the top surface 11a of the wing portion 11 in a rotation direction of the shaft portion 10 of the first tapered screw 2 and the second tapered screw 3. Further, the outer edge portion 21a of the first discharge perforation 21 is located on the inside, in the radial direction, of the track TR of the outer end 11b of the wing portion 11. The same applies to the second discharge perforation 22. However, the first discharge perforation 21 has a shape in which a width in a rotation direction of the shaft portion 10 is larger than a length in the radial direction. Further, the same applies to the second discharge perforation 22.

Also in this configuration, the wing portion 11 of the first tapered screw 2 passes through the entire first discharge perforation 21 in the radial direction RD of the shaft portion 10. Thus, a material may be separated by the wing portion 11. The same applies to the second tapered screw 3. Note that, in FIG. 5, the wing portion 11 has a shape wider in a rotation direction of the shaft portion 10 than the wing portion 11 illustrated in FIG. 4.

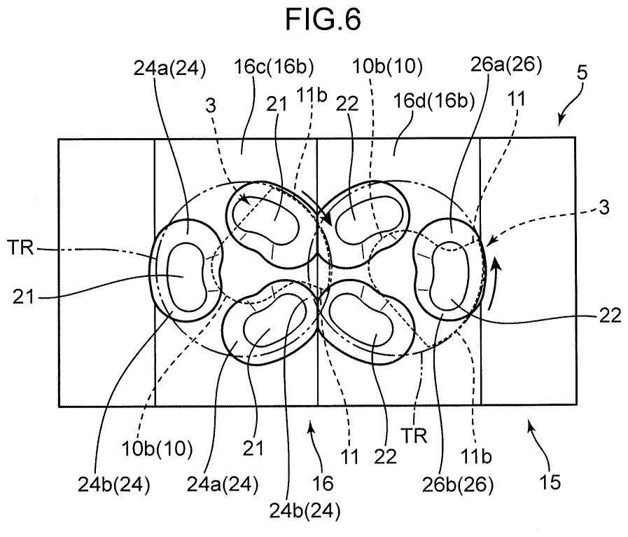

In the die plate 5 illustrated in FIG. 4, the rear side surface 24b of the first discharge perforation 21 is orthogonal to the first bottom surface portion 18a. On the other hand, in the die plate 5 illustrated in FIG. 6, the inner peripheral surface 24 itself defining the first discharge perforation 21 is formed in a tapered shape such that an opening area increases in the material discharge direction. That is, the inner peripheral surface 24 is inclined in an entire circumferential direction including not only the front side surface 24a but also the rear side surface 24b of the first discharge perforation 21. The second discharge perforation 22 is similarly formed.

In this configuration, each of the first discharge perforations 21 itself and each of the second discharge perforations 22 itself are formed as tapered holes. For this reason, it is possible to further suppress a cut material to adhere to the inner peripheral surface 24 of the first discharge perforation 21 and the inner peripheral surface 26 of the second discharge perforation 22. Note that a shape of the first discharge perforation 21 and a shape of the second discharge perforation 22 are not limited to the shapes illustrated in FIG. 6. Further, a shape of the top surface 11a of the wing portion 11 is not limited to a shape illustrated in FIG. 6.

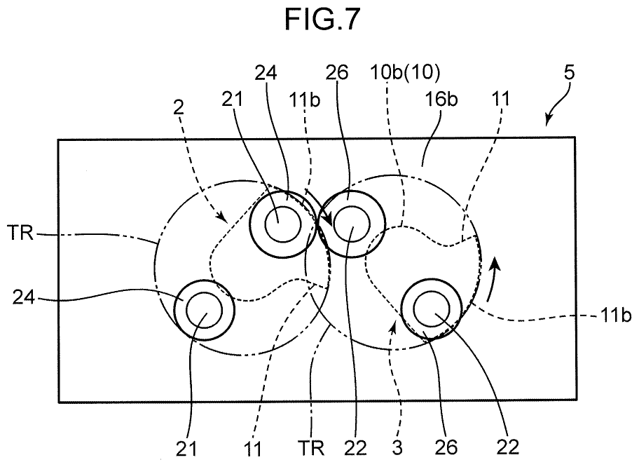

A shape of the first discharge perforation 21 and a shape of the second discharge perforation 22 may be a shape having a round cross section as illustrated in FIG. 7.

It should be understood that the embodiment disclosed herein is illustrative in all respects and is not restrictive. The present invention is not limited to the above embodiment, and various modifications, improvements, and the like can be made without departing from the gist of the present invention. For example, a mechanism for making the gap G between the tapered screws 2 and 3 and the die plate 5 adjustable may be provided. For example, by providing a shim (not illustrated) at a base end portion of the tapered screws 2 and 3, a width of the gap G may be finely adjusted so that the gap G between the tapered screws 2 and 3 and the die plate 5 becomes narrower.

Here, the embodiment will be outlined.

A screw extruder according to an aspect of the present invention includes a pair of tapered screws arranged so as to approach each other toward a tip, each of the pair of tapered screws having a shaft portion and a wing portion spirally provided on an outer peripheral surface of the shaft portion and including a flat top surface, a driving device that generates driving force for rotating the pair of tapered screws, a casing that accommodates the pair of tapered screws and has an inlet for receiving a material and a passage port for allowing a material to pass through, and a die plate attached to the casing so as to close the passage port. The die plate includes a plurality of discharge perforations arranged at positions corresponding to the pair of tapered screws, and positions and shapes of a plurality of the discharge perforations are set such that size of an overlapping region of the top surface of the wing portion of each of the pair of tapered screws and a corresponding discharge perforation when viewed in a material extrusion direction periodically changes when the pair of tapered screws is rotated by the driving device. A material extruded by the pair of tapered screws is cut by increase in the size of the overlapping region between the corresponding discharge perforation and the top surface of the wing portion.

In the screw extruder, a material is gradually pressurized as a pair of the tapered screws rotates and the material is sent toward a tip by the wing portion. In this state, the material flows into a plurality of the discharge perforations of the die plate. When a pair of the tapered screws rotates, size of an overlapping region between the flat top surface of the wing portion of each of a pair of the tapered screws and the corresponding discharge perforations when viewed in a material extrusion direction changes periodically. Then, when the overlapping region between the discharge perforations and the top surface of the wing portion becomes larger, a material is cut. At this time, since the size of the overlapping region periodically changes, a material continuously flowing into the discharge perforations is cut every predetermined time interval. For this reason, since there is little variation in size of cutting of a material, it is possible to obtain an extruded material having a predetermined weight without molding of a material into a sheet shape. Therefore, the screw extruder that supports a material that is difficult to be molded into a sheet shape is obtained.

An edge portion of the corresponding discharge perforation located on an outermost side in a radial direction of the shaft portion may be located on the inside, in a radial direction of the shaft portion, of a track of an outer end of the top surface of the wing portion during rotation.

In this aspect, when viewed in the material extrusion direction, a top surface of the tapered screw passes through the entire region of the corresponding discharge perforation. For this reason, it is possible to prevent a material from being left uncut in the entire region of the discharge perforation in the radial direction of the shaft portion.

The die plate may be provided with a heater. In this aspect, since the temperature of the die plate can be raised, it is possible to prevent a material after cutting from adhering to the die plate.

Among inner peripheral surfaces defining the plurality of the discharge perforations, at least a front side surface facing the opposite side to a rotation direction of the pair of tapered screws is inclined such that an opening area increases in a material discharge direction.

In this aspect, it is possible to suppress a material after cutting to adhere to the front side surface of the discharge perforation and staying. That is, if a material is cut and adheres to the inner peripheral surface of the discharge perforation, the material may stay in the discharge perforation. In that case, the material may be connected to a material that is extruded next. For this reason, since at least the front side surface of the discharge perforation is inclined, adhesion of a cut material to the front side surface of the discharge perforation is suppressed, so that adhesion between the cut materials can be suppressed.

The top surface of the wing portion may have, as viewed in the material extrusion direction, a shape having a period of closing the corresponding discharge perforation when the pair of tapered screws rotates. In this aspect, cutting performance of a material can be enhanced.

A gap between the top surface of the wing portion and the die plate may be 10 mm or less. In this aspect, cutting performance of a material can be enhanced.

As described above, the screw extruder according to the above embodiment can support a material that is difficult to be molded into a sheet shape.

This application is based on U.S. Provisional application No. 63/707,480 filed in United States Patent and Trademark Office on Oct. 15, 2024, the contents of which are hereby incorporated by reference.

1. A screw extruder comprising:
a pair of tapered screws arranged so as to approach each other toward a tip, each of the pair of tapered screws having a shaft portion and a wing portion spirally provided on an outer peripheral surface of the shaft portion and including a flat top surface;
a driving device that generates driving force for rotating the pair of tapered screws;
a casing that accommodates the pair of tapered screws and has an inlet for receiving a material and a passage port for allowing a material to pass therethrough; and
a die plate attached to the casing so as to close the passage port, wherein the die plate includes a plurality of discharge perforations arranged at positions corresponding to the pair of tapered screws,
positions and shapes of the plurality of discharge perforations are set such that size of an overlapping region of the top surface of the wing portion of each of the pair of tapered screws and a corresponding discharge perforation when viewed in a material extrusion direction periodically changes when the pair of tapered screws is rotated by the driving device, and
a material extruded by the pair of tapered screws is cut by increase in the size of the overlapping region between the corresponding discharge perforation and the top surface of the wing portion.

2. The screw extruder according to claim 1, wherein an edge portion of the corresponding discharge perforation located on an outermost side in a radial direction of the shaft portion is located on an inside, in a radial direction of the shaft portion, of a track of an outer end of the top surface of the wing portion during rotation.

3. The screw extruder according to claim 1, wherein the die plate is provided with a heater.

4. The screw extruder according to claim 1, wherein among inner peripheral surfaces defining the plurality of discharge perforations, at least a front side surface facing an opposite side to a rotation direction of the pair of tapered screws is inclined such that an opening area increases in a material discharge direction.

5. The screw extruder according to claim 1, wherein the top surface of the wing portion has, as viewed in a material extrusion direction, a shape having a period of closing the corresponding discharge perforation when the pair of tapered screws rotates.

6. The screw extruder according to claim 1, wherein a gap between the top surface of the wing portion and the die plate is 10 mm or less.
